(19) United States
(12) Patent Application Publication
(10) Pub. No.: US 2016/0061341 A1
(43) Pub. Date: Mar. 3, 2016

(54) VALVE DEVICE WITH ENHANCED RESEAT CAPABILITIES

(71) Applicant: Kepner Products Company, Villa Park, IL (US)

(72) Inventors: David K. Broschka, Western Springs, IL (US); James P. Beck, Wheaton, IL (US); James B. Warren, Carol Stream, IL (US)

(73) Assignee: Kepner Products Company

(21) Appl. No.: 14/837,685

(22) Filed: Aug. 27, 2015

Related U.S. Application Data
(60) Provisional application No. 62/043,113, filed on Aug. 28, 2014.

(51) Int. Cl. F16K 17/04; F16K 27/02

(52) U.S. Cl. CPC F16K 17/0473; F16K 27/0209

(57) ABSTRACT

A cartridge for being placed in a valve or other enclosure for use with a pressure system includes a cartridge body defining a cartridge cavity and having a poppet disposed therein. The poppet is seated against a valve seat that defines the outlet of the cartridge. The cartridge also defines an inlet, through which inlet pressure will flow into the cartridge cavity. The poppet is biased toward the valve seat and toward the outlet. As inlet pressure flows into the cartridge cavity, pressure buildup will act on a pressure area, which has an annular shape and excludes an outlet area defined by the valve seat. The poppet moves away from the valve seat and outlet and toward an inlet end of the cartridge in response to pressure buildup and moves back toward the outlet to reseat against the valve seat when pressure is relieved.

### CROSS REFERENCE TO RELATED APPLICATION

This application claims the benefit of U.S. Provisional Application No. 62/043,113 filed on Aug. 28, 2014, the entire contents of which is hereby incorporated by reference.

### FIELD OF THE INVENTION

The present invention relates to relief check valves and, more particularly, to a relief check valve with enhanced reseat performance, which includes reducing the difference between valve open and closing pressure resulting in faster reseat action.

### BACKGROUND OF THE INVENTION

Relief check valves are commonly known in the art. Conventional relief check valves are used in a variety of applications involving fluid flow, such as hydraulic or pneumatic systems. Relief check valves generally operate to stay closed when system pressure at the location of the valve is below a predetermined level, and to open when pressure at the valve rises above the predetermined level. When the valve opens, the fluid in the system will flow through the valve, lowering the pressure of the system at the location of the valve. When pressure returns to a level below the predetermined level, the valve will close or “reseat.”

With reference to FIGS. 1-2, a conventional relief check valve 10 includes a main body 12 defining a cavity 14, an inlet 16, and an outlet 18 disposed at opposing ends of the valve 10 such that the valve 10 can be installed on a system pressure line (not shown). A cap 20 is connected at the inlet end of the main body 12. The cap 20 generally defines the inlet 16 of the valve 10, with the body 12 defining the outlet 18. The cap 20 and body 12 combine to define a flow path 22 therethrough. An annular retainer 24 is mounted within the body 12 and is restricted from moving in the direction of the outlet 18. An o-ring 26 is disposed between the cap 20 and the retainer 24 to seal the cap 20 to the body 12.

A poppet 28 is mounted within the body 12 between the cap 20 and the outlet 18. The poppet 28 extends through an opening 30 defined by the retainer 24. The poppet 28 includes a tapered outer surface that cooperates with a corresponding tapered inner surface of the cap 20. The poppet 28 defines a reaction face 32 that faces the inlet 16 of the valve 10, where the face 32 generally extends transverse to a longitudinal axis L of the valve 10, and extends across the opening of the inlet 16. The poppet 28 defines an inner cavity 34 that fluidly communicates with areas outside the poppet 28 through a plurality of radial passageways 36 extending through the poppet 28.

A spring 38 is mounted within the body 12, and extends from a surface near the outlet 18 to an opposing surface of the poppet 28 within the cavity 34 of the poppet 28. The force of the spring 38 biases the poppet 28 toward a closed and seated position against the cap 20.

As fluid pressure builds up at the inlet 16 and acts against the reaction face 32 of the poppet 28, the pressure build up will force the poppet 28 against the bias of the spring 38. When the pressure reaches a predetermined level, the force will overcome the spring bias, moving the poppet 28 away from the inlet 16, allowing fluid to flow around the outer surface of the poppet 28. Fluid will travel through the radial passageways 36 and into the poppet cavity 34. Fluid will then pass through the cavity 34 toward and through the outlet 18.

As fluid flows past the poppet 28, pressure on the inlet side will decrease. Once the pressure on the inlet side decreases relative to the pressure on the outlet side, which includes spring force bias of the spring 38, the poppet 28 will move back to its closed and seated position.

The relationship of the forces on each side of the valve can be demonstrated by a force balance analysis according to the following equation. P_{crack}−Pᵣₑₛₑₐₜ=Fᵣₑₛₑₐₜ/A, where P_{crack} is the pressure differential across the valve 10 when the valve 10 opens, Pᵣₑₛₑₐₜ is the pressure differential reached while the valve 10 is closing when the o-ring 26 flexes around all possible leak paths to shut off flow through the valve 10, A is the pressure area, and Fᵣₑₛₑₐₜ is the force on the o-ring seat from the poppet 28 that occurs when the pressure differential across the valve is equal to Pᵣₑₛₑₐₜ.

While relief check valves of this type are known, improvements can be made to their performance.

### BRIEF DESCRIPTION OF THE DRAWINGS

FIG. 1 illustrates a conventional prior art valve with reseat capability;

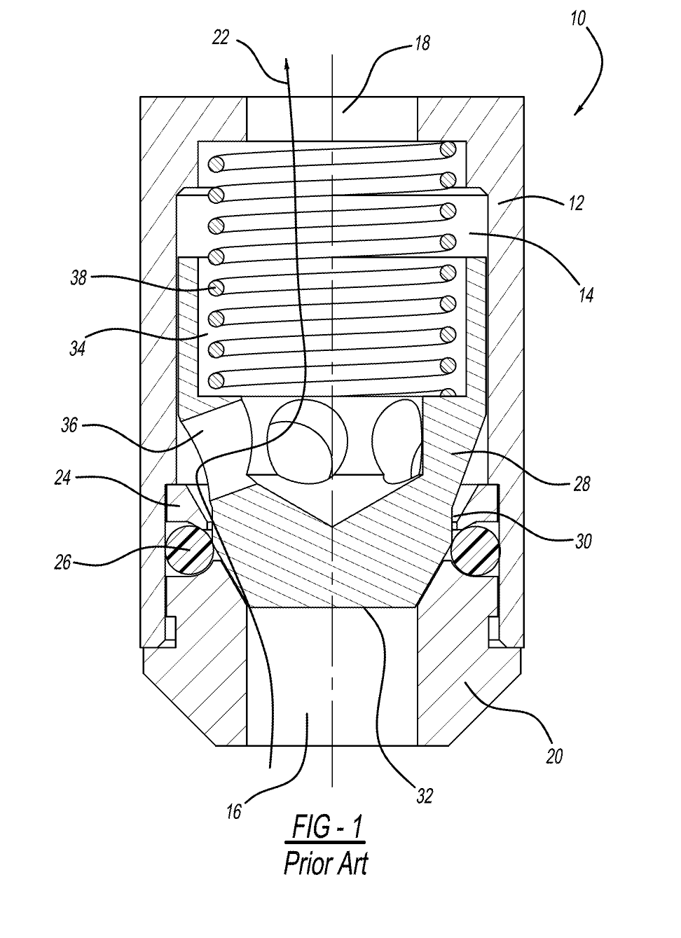

FIG. 2 illustrates the forces acting on the prior art valve;

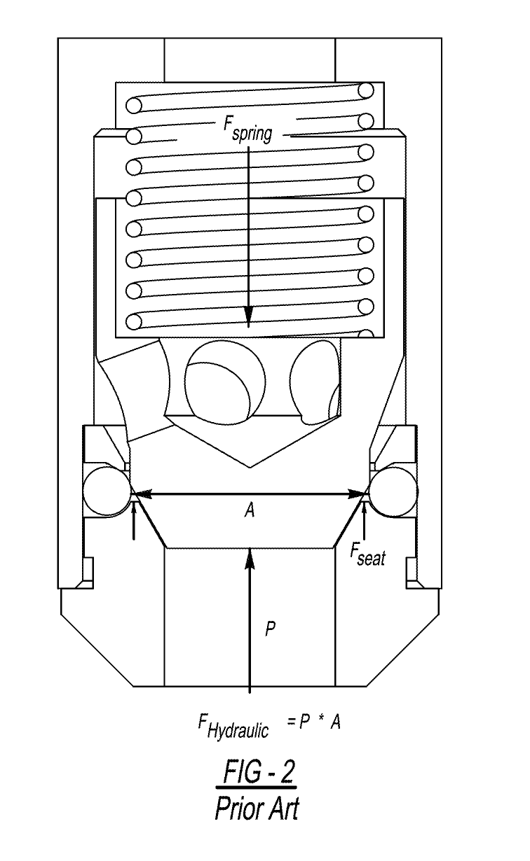

FIG. 3 illustrates a schematic exploded view of one embodiment of a cartridge according to the present invention for insertion into a valve body or other enclosure for use with a system pressure line;

FIG. 4 illustrates an isometric view of the cartridge of FIG. 3 for use with an improved valve;

FIG. 5 illustrates a cross-section of the cartridge of FIG. 3, including a poppet disposed within a cavity defined by the cartridge and being biased and seated against a valve seat at an outlet end of the cartridge;

FIG. 6 illustrates a cross-section of the cartridge of FIG. 3 and the forces acting on the poppet during inlet pressure buildup within the cartridge cavity, and the areas on which inlet pressure acts and doesn't act when the poppet is seated against the valve seat;

FIG. 7 illustrates the force and pressure progression during pressure buildup and the crack condition;

FIG. 8 illustrates the forces acting on the poppet when the poppet is moving toward being reseated with the valve seat;

FIG. 9 illustrates the pressure and force progression of the reseat condition;

FIG. 10 illustrates the combination of the crack condition progression and the reseat condition progression;

FIG. 11 includes equations related to the improved reseat performance of the present invention;

FIG. 12 illustrates a comparison of the reseat performance between the cartridge and the prior art valve;

FIG. 13 illustrates another comparison of the reseat performance between the cartridge and the prior art valve where there is a variance in reseat force;

FIG. 14 illustrates an alternative embodiment of a cartridge according to the present invention;

FIG. 15 illustrates an alternative embodiment of a cartridge according to the present invention having an inlet insert and a bellows and illustrating a flow path of the pressurized fluid through the cartridge;

FIG. 16 illustrates the area on which the pressurized fluid acts on the cartridge of FIG. 15; and

FIGS. 17 and 18 illustrate a further embodiment of a cartridge according to the present invention having a rolling diaphragm and a retainer through which pressurized fluid can flow into the diaphragm.

### DETAILED DESCRIPTION OF THE INVENTION

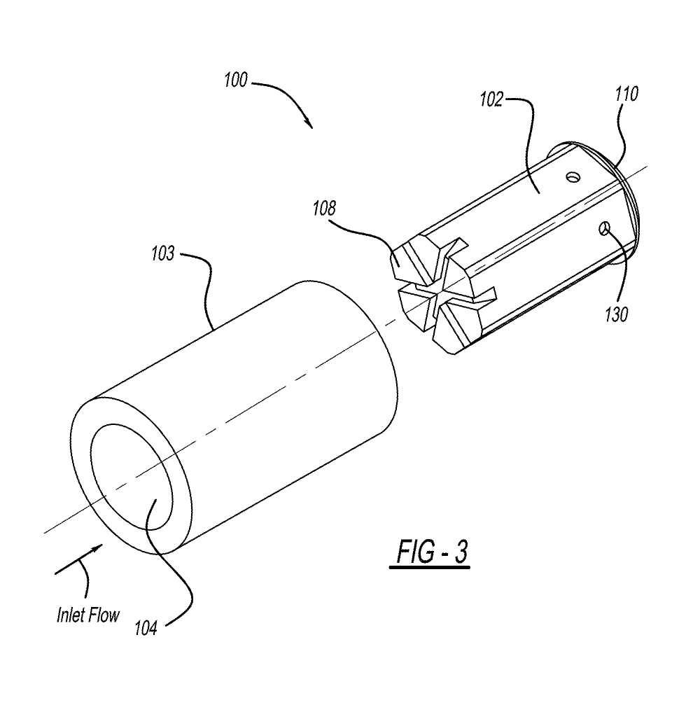

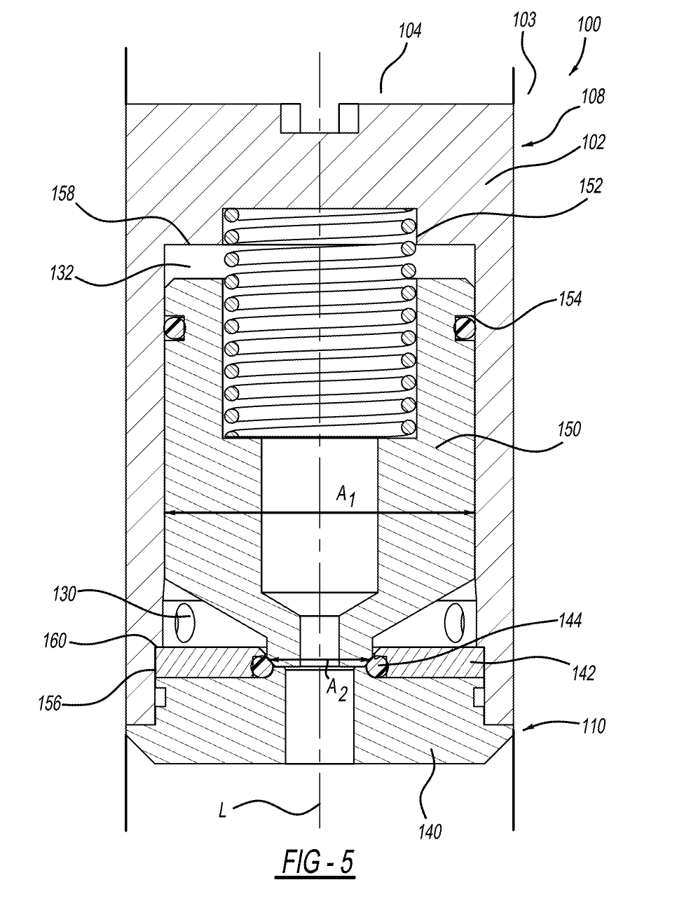

With reference to FIGS. 3-5, a valve 100 is shown that provides improved reseat performance relative to prior art valves. It is desirable for the difference between P_{crack} and Pᵣₑₛₑₐₜ to be as small as possible. There are two options for improvement to reduce the size of the difference: Lower Fᵣₑₛₑₐₜ and increase the pressure area. Fᵣₑₛₑₐₜ is affected by several variables including the condition of the sealing surface and o-ring durometer. The design of the valve 100 improves reseat performance by increasing the pressure area without increasing the size of the o-ring seal used on the valve seat, which holds Fᵣₑₛₑₐₜ constant. Of course, it will be appreciated that variations of the design of the valve 100 could also be made where the o-ring seal size is changed and Fᵣₑₛₑₐₜ changes.

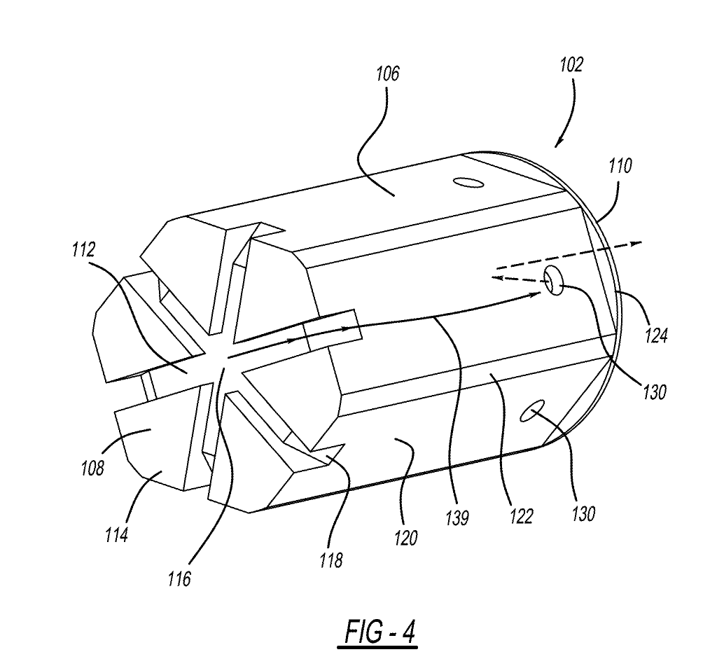

With reference to FIGS. 3-5, the valve 100 includes a cartridge 102 that is configured to be installed in a valve body or other enclosure 103, such as a manifold or other body that defines a cavity that is configured to receive pressurized fluid. The cartridge 102 can be installed by being slipped in to a cavity or bore 104 of the valve body 103. The cartridge can be installed in the valve body 103 in other manners, such as via a threaded connection or other known methods. As shown in FIG. 4, the slip-in cartridge 102 has a main body portion 106 having generally hexagonal outer profile. The main body portion 106 has an inlet end 108 and an outlet end 110.

The inlet end 108 includes a plurality of slots 112 defined by the main body 106. The slots 112 are recessed relative to an inlet surface 114 disposed at the inlet end 108. The slots 112 have a generally rectangular channel-type shape.

The slots 112 extend radially from a slot hub 116. The slot hub 116 is disposed at the center of the inlet surface 114, with the slots 112 extending outward from the slot hub 116. The slot hub 116 and slots 112 have a depth extending into the inlet surface 114 that is the same at the intersection of the slots 112 and slot hub 116. The slots 112 extend transverse to a longitudinal axis L of the cartridge 102.

The slots 112 include a tapered portion 118 at their outer ends. The tapered portion 118 has an increasing depth relative to the inlet surface 114. The tapered portion 118 is illustrated as having a generally constant slope. However, in another approach, the tapered portion 118 could be curved and define a concave or convex surface.

In another approach, the slots 112 could be tapered from the slot hub 116 with a curved slope or constant slope. In this approach, the slot hub 116 could have a flat surface, with the taper beginning at the outer edge of the slot hub 116. In another approach, the slots 112 could taper from a central point, with the slot hub 116 defining a crown or apex.

As illustrated, there are six slots 112, corresponding to the hexagonal shape of the cartridge. In another approach, additional slots 112 could be used while still using a hexagonal shape. In yet another approach, fewer than six slots 112 could be used while still using a hexagonal shape. For example, if desired, one, two, three, four, or five slots 112 could be used with a hexagonal shaped cartridge 102. It will be appreciated that other shapes of the cartridge 102 could also be used, such as pentagonal, rectangular, octagonal, triangular, or other polygonal shapes, with the number of slots 112 corresponding to the number of sides of the cartridge 102, exceeding the number of sides, or having fewer slots than the number of sides.

The cartridge 102 further includes a plurality of outer flats 120 in the form of flat outer surfaces. The number of flats 120 generally defines the general shape of the cartridge. For example, the illustrated hexagonal cartridge 102 has six flats 120. The cartridge further includes a number of transition surfaces or chamfers 122 that are disposed at the intersection of each of the flats 120. The chamfers have a generally flat shape, but are smaller in width than the flats 120. The chamfers 122 can also be in the form of a radiused edge or other curved transition.

The flats 120 and chamfers 122 extend from the inlet surface 114 at the inlet end 108 toward the outlet end 110. The outlet end 110 includes a generally circular flange 124 or rim. The flange 124, having a circular outer edge, thereby defines a plurality of curved edges that extend radially outward from the intersection of the flats 120 and the flange 124. The amount that the flange 124 extends from each flat is higher at a middle portion of the flats 120 than at the intersection between the flats 120 and chamfers 122. In one approach, the flange 124 does not extend from the chamfer 120, or extends a nominal amount. Put another way, the diameter of the flange 124 generally corresponds to the width of the cartridge 102 as measured between diametrically opposed chamfers 122.

The cartridge 102 further defines a plurality of inlet ports 130 that are disposed adjacent the outlet end 110 of the cartridge 102. The inlet ports 130 extend through a sidewall of the cartridge body 106 and into an inner cavity 132 defined within the cartridge body 106. The inlet ports 130 thereby provide direct fluid communication between the area outboard of the flats 120 and the inner cavity 132.

The number of inlet ports 130 generally corresponds to the number of flats 120. As illustrated, the hexagonal body 106 of the cartridge 102 has six inlet ports 130 that correspond with the six flats 120. The inlet ports 130 are preferably located in the center or middle of the flats 120 as measured across the flat transverse to the longitudinal axis L. The inlet ports 130 are located closer to the outlet end 110 than the inlet end 108. As illustrated, the inlet ports 130 are each located at the same longitudinal distance from the inlet surface 114. However, it will be appreciated that the inlet ports 130 could be located at different longitudinal distances relative to each other.

In an alternative approach, the inlet ports 130 could be located at the longitudinal middle of the flats 120, or even at a location that is longitudinally closer to the inlet end 108 than the outlet end 110.

As described above, the number of inlet ports 130 preferably corresponds to the number of flats 120. However, fewer inlet ports 130 could be used or, alternatively, additional inlet ports could be used. For example, some flats 120 may not include inlet ports 130, or some flats may include more than one inlet port 130. Additional inlet ports 130 per flat 120 could be disposed at a different lateral location, a different longitudinal location, or both.

Preferably, for each slot 112 that intersects a flat 120, the flat 120 will include at least one inlet port 130. However, it is possible for a flat 120 having a corresponding slot 112 to be without an inlet port 130. It will be appreciated that various other configurations of slots 112, flats 120, and inlet ports 130 could also be used. The combination of slots 112, flats 120, and inlet ports 130 will ultimately affect the fluid flow, as further described below.

The cartridge 102 is configured to be inserted within the bore of the valve body, such that a flow path or flow paths 139 are created so that fluid flows through the slots 112, along the flats 120, and through the inlet ports 130 into the cavity 132.

For example, when the cartridge 102 is installed within the valve body 103, fluid will flow along the flats 120 through a space in the bore defined radially between the flats 120 and the valve body 103. The fluid flow will be blocked by the circular flange 124, and will be forced through the inlet ports 130 into the cavity 132.

As described above, the valve 100 includes a main body 103 defining the bore 104, into which the cartridge 102 is received. The bore 104 is preferably drilled or otherwise bored into the valve body 103, and has a generally cylindrical cavity shape. However, it will be appreciated that other shapes of the bore 104 could be used that still permit the cartridge 102 and valve body 103 to define a radial space therebetween through which fluid flow along the flats 120, as described above. For example, the bore 104 could have a polygonal shape and the cartridge 102 could have a different polygonal shape. In another approach, the bore 104 could have a polygonal shape and the cartridge 102 could have a generally rounded shape. Further discussion will refer to embodiments where the bore 104 is generally cylindrical and the cartridge 102 is polygonal.

As described above, the cartridge 102 defines the inner cavity 132. The cartridge 102 includes a cap 140 installed and attached to the cartridge 102 at the outlet end 110. The cartridge 102 further includes a retainer 142 installed adjacent the cap 140, with the retainer 142 being disposed on the cavity side of the cap 140. The cartridge 102 further includes an o-ring 144 disposed between the cap 140 and the retainer 142. The cartridge 102 further includes a poppet 150 disposed within the cavity 132.

With further reference to the cavity 132, the cavity includes three portions having a varying diameter that are in fluid communication with each other: a first portion 152, a second portion 154, and a third portion 156. The first portion 152 has a smaller diameter than the second portion 154, which has a smaller diameter than the third portion 156.

The second portion 154 is the largest portion as measured longitudinally, and the poppet 150 generally travels longitudinally within the second portion 154. The third portion is generally used to house the retainer 142 and a portion of the cap 140. The first portion 152 will be described below with further reference to the poppet 150.

The increasing diameters of the first, second, and third portions 152, 154, 156 further define a pair of annular ledges 158 and 160. The retainer 142 is sandwiched between the cap 140 and the ledge 160.

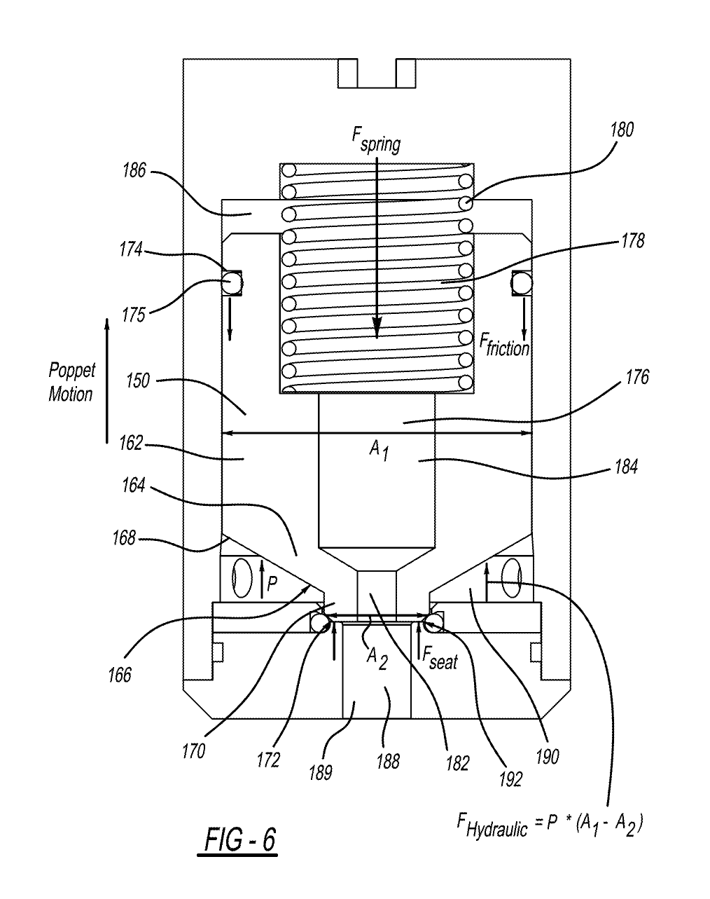

With reference to FIG. 6 and the poppet 150, the poppet 150 includes a body portion 162 and a tapered nose portion 164 at an inlet end 166 of the poppet 150. The inlet end 166 of the poppet 150 is disposed adjacent the outlet end 110 of the cartridge 102. The inlet end 166 of the poppet 150 corresponds to the location of the inlet ports 130 that extend through the cartridge 102. The body portion 162 is disposed toward the inlet end 108 of the cartridge relative to the nose portion 164.

The nose portion 164 has a generally tapered shape and includes a first tapered portion 168, a cylindrical portion 170, and a second tapered portion 172. The first tapered portion 168 extends from the body portion 162 and transitions into the cylindrical portion 170, which transitions into the second tapered portion 172. The second tapered portion 172 is relatively small and is designed to contact the o-ring 144 held by the retainer 142.

The body portion 162 of the poppet 150 has a generally cylindrical shape and extends toward the inlet end 108 of the cartridge 102 away from the nose portion 164. The body portion 162 has a diameter that generally corresponds to the diameter of the second portion 154 of the cartridge cavity 132, but it is preferably slightly smaller to allow the poppet 150 to slide within cavity 132 with little resistance. The body portion 162 of the poppet defines a circumferential recess 174 disposed at the end of the poppet 150 opposite the nose portion 164. The circumferential recess 174 houses a low friction sealing member 175 that is sized and dimensioned to contact an inner surface of the cavity 132 to provide a seal between the poppet 150 and the cavity 132 while limiting friction between the poppet 150 and the cavity 132 such that the poppet 150 can slide within the cavity 132.

The combination of the cartridge 102, the poppet 150, the retainer 142, the o-ring 144, and the cap 140 cooperate to define various chambers within the cavity 132, some of which are in fluid communication through operation of the valve 100, with some being fluidly separated when the valve 100 is closed and brought into fluid communication when the valve 100 is open.

The poppet 150 itself defines an inner cavity 176 having a varying diameter along its longitudinal length. A large diameter portion 178 of the cavity 176 is defined by the body portion 162 and is disposed at the end of the poppet 150 opposite the nose portion 164. The large diameter portion 178 is open to the cavity 132 of the cartridge. The large diameter portion 178 receives a spring 180, with the spring extending out of the large diameter portion 178 and into the cavity 132, and extending further into the first portion 152 of the cavity. The diameters of the first portion 152 of the cartridge cavity 132 and the large diameter portion 178 of the poppet cavity 176 are selected to correspond generally to the diameter of the spring 180, such that the spring 180 is held in place radially and longitudinally between the poppet 150 and the cartridge 102.

The poppet cavity 176 also includes a small diameter nose portion 182, which extends through the end of the nose portion 164 of the poppet 150. The poppet cavity 176 further includes a medium diameter portion 184 that extends between the small diameter portion 182 and the large diameter portion 178. The medium diameter portion 184 and small diameter portion 182 can also include a tapered transition extending therebetween.

The poppet 150 and the cartridge body 106 cooperate to define a spring chamber 186 therebetween that includes the poppet cavity 176. The low friction sealing member 175 separates the spring chamber 186 from inlet pressure that flows through the inlet ports 130 and acts on the inlet end of the poppet 150.

The cap 140 defines a bore or hole 188 that is centered on the longitudinal axis L of the valve 100. The hole 188 defines an outlet chamber 189. The outlet chamber 189 is in fluid communication with the spring chamber 186, in particular via the small diameter nose portion 182 of the poppet cavity 176 when the valve 100 is closed. Pressure within the outlet chamber 189 can be referred to as Pₒᵤₜₗₑₜ. The small diameter nose portion 182 of the poppet cavity 176 equalizes pressure between the spring chamber 186 and the outlet chamber 189.

The outer surface of the nose portion 164 of the poppet 150 and the cartridge body 106 combine to define an annular inlet cavity 190 that extends around the nose portion 164. The inlet cavity 190 is in fluid communication with the inlet ports 130 and receives fluid inlet pressure Pᵢₙₗₑₜ.

Thus, pressure within the spring chamber 186 equals Pₒᵤₜₗₑₜ. The pressure within the inlet cavity 190 equals Pᵢₙₗₑₜ when the valve 100 is closed. The fluid pressure Pᵢₙₗₑₜ within the inlet cavity 190 acts on the outer surface of the tapered nose portion 164.

The pressure area acting on the poppet 150 is equal to area A1−area A2. Area A1 corresponds to the outer diameter of the poppet body 162 and the inner diameter of the cartridge cavity 132. Area A2 corresponds to the diameter of an opening defined by the o-ring 144 held by the retainer 142. The second tapered portion of the poppet 150 contacts the o-ring 144 held by the retainer 142 to seal the outlet cavity 189 across area A2.

The retainer 142 and o-ring 144 combine with the cap 140 to define a valve seat 192, against which the poppet 150, in particular the nose portion 164, is seated to seal the valve 100.

The above described valve 100 provides for zero leakage performance due to the existence of two flexible seals. One of the seals is provided between the poppet 150 and the cartridge body 106 via the low friction sealing member 175, which seals the spring chamber 186 from the inlet pressure Pᵢₙₗₑₜ that flows through the inlet ports 130 and into the inlet cavity 190. The other seal is provided at the outlet end 110 of the cartridge by the o-ring 144 disposed within the retainer 142.

The above described valve 100 operates in an opposite direction from traditional valves. In a traditional valve, inlet pressure acts on the reaction face of the poppet, and the force of the inlet pressure forces the poppet away from the inlet and toward the outlet.

In the valve 100 of the present embodiment, inlet pressure Pᵢₙₗₑₜ enters through the inlet end of the cartridge 102 and through the flow path and the inlet ports 130 and into the inlet cavity 190. The inlet pressure Pᵢₙₗₑₜ ultimately acts on the outer surface of the nose portion 164 (the reaction face) of the poppet 150 to force the poppet 150 away from the outlet end 110 and toward the inlet end 108, which is in directional contrast to the operation of traditional valves.

The poppet 150 of the present embodiment of the valve 100 is therefore biased toward the outlet end 110. The poppet of a prior traditional valve is biased toward and against the inlet.

Further, the pressure area of the reaction face of the present embodiment of the valve 100 is defined by the outer diameter of the poppet 150 (resulting in area A1), excluding the diameter of the portion of the poppet 150 that is sealed against the valve seat 192 (resulting in area A2). The excluded diameter of the poppet 150 is not in contact with inlet fluid and therefore Pᵢₙₗₑₜ does not act against this excluded area A2 when the poppet 150 is seated. The reaction face of the prior traditional valve is defined by the relatively small diameter area within its valve seat of the poppet facing the inlet, and does not include areas radially outward from the valve seat. Accordingly, the reaction face area or pressure area A of the present embodiment of the valve 100 is greater than the reaction face area of prior traditional valves.

Having described the general structure and operation of the valve 100, the following equations will provide additional detail regarding the forces acting on the valve 100 and the operation of the valve 100.

With reference to FIG. 6, which illustrates the forces acting on the valve 100, the force balance equations for the Crack condition (the poppet 150 being moved away from the valve seat 192 and away from the outlet end 110) are as follows:

F_{hydraulic}+Fₛₑₐₜ=F_{spring}+F_{friction}

F_{hydraulic} is the hydraulic force due to Pᵢₙₗₑₜ acting on the poppet 150, with Fₛₑₐₜ being the reaction force acting on the poppet 150 by the valve seat 192. F_{hydraulic}=P*(A1−A2), where P is the pressure differential acting across the valve 100. F_{spring} is the force of the spring 180 that is forcing the poppet 150 toward the outlet end 110 away from the inlet end 108. F_{friction} is the frictional force toward the outlet, acting against the movement of the poppet 150 away from the outlet end 110 and toward the inlet end 108.

Thus, the above balance equation can be re-written as:

Fₛₑₐₜ=F_{spring}+F_{friction}−F_{hydraulic}.

The balance equation can be further re-written as:

Fₛₑₐₜ=F_{spring}+F_{friction}(P*(A1−A2)), where P is the pressure differential across the valve.

The crack condition occurs when P=P_{crack} and Fₛₑₐₜ=0. Applying these conditions to the above equation results in:

F_{spring}=P_{crack}*(A1−A2)−F_{friction}

Returning to the Fₛₑₐₜ equation, Fₛₑₐₜ=P_{crack}*(A1−A2)−F_{friction}+F_{friction}−P*(A1−A2), so:

Fₛₑₐₜ=P_{crack}*(A1−A2)−P*(A1−A2)

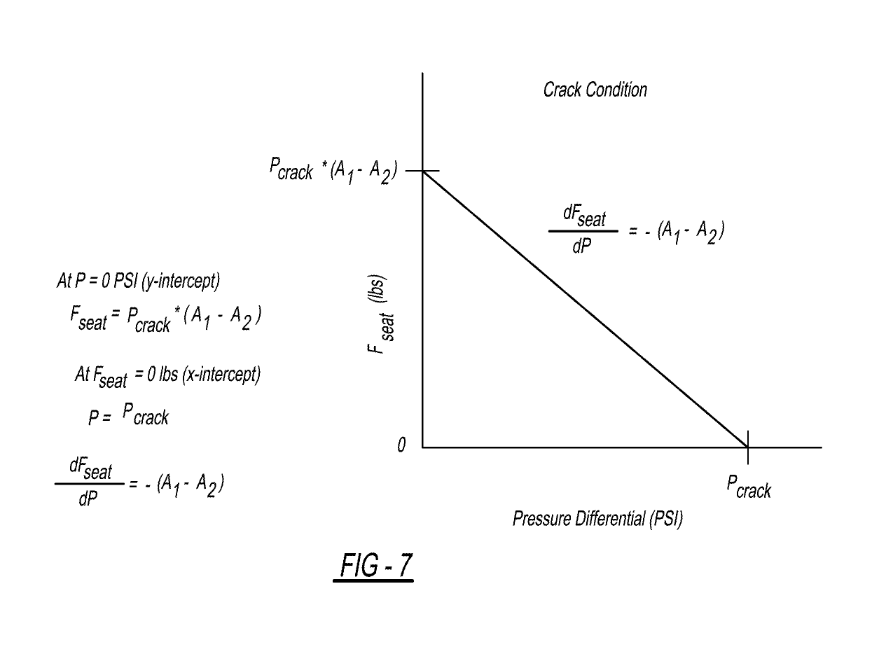

FIG. 7 illustrates a graph of the relationship between Fₛₑₐₜ and the pressure differential P across the valve 100 leading to the crack condition. As stated above, the crack condition occurs when Fₛₑₐₜ is zero and P=P_{crack}.

When the pressure differential is zero, the force acting on the valve seat 192, Fₛₑₐₜ, is equal to P_{crack}*(A1−A2). This is illustrated by the y-intercept of the illustrated graph. When Fₛₑₐₜ is zero, this is the crack condition, the pressure differential across the valve is P_{crack}, as illustrated by the x-intercept of the illustrated graph. The relationship between Fₛₑₐₜ and the pressure differential P across the valve 100 is illustrated by the graph. When the pressure differential P is above zero but below P_{crack}, the Fₛₑₐₜ is also above zero, but smaller than P_{crack}*(A1−A2). As the pressure differential across the valve increases, Fₛₑₐₜ decreases. The relationship between Fₛₑₐₜ and P can be determined using the following equation:

(dFₛₑₐₜ/dP)=(−(A1−A2))

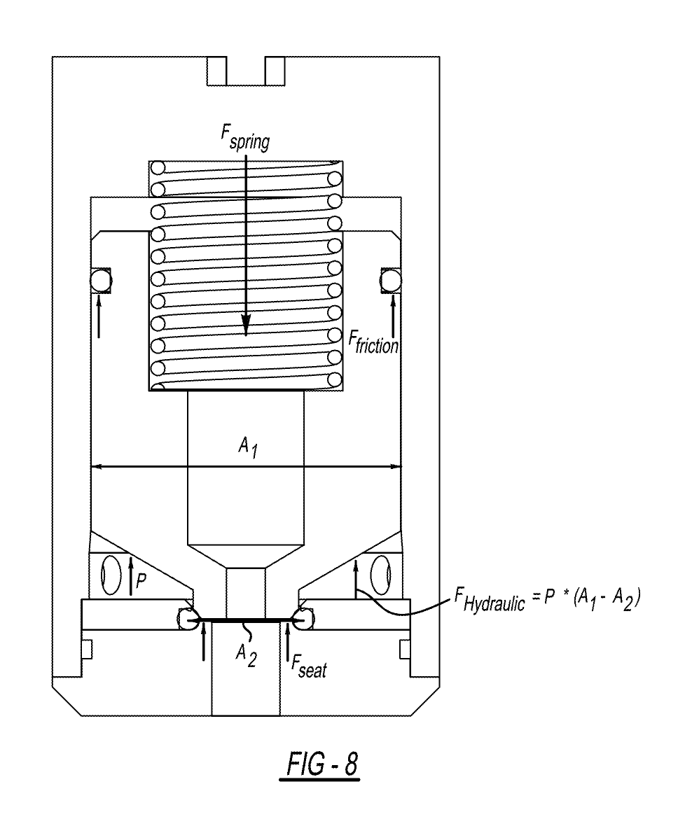

With reference to FIG. 8, the force balance equations for Reseat of the valve 100 (the poppet 150 being moved toward the valve seat 192 and toward the outlet end 110 of the valve 100) are as follows:

F_{spring}=F_{hydraulic}+Fₛₑₐₜ+F_{friction}

Fₛₑₐₜ=F_{spring}−F_{friction}−F_{hydraulic}

Fₛₑₐₜ=F_{spring}−F_{friction}−(P*(A1−A2))

From the prior analysis, F_{spring}=P_{crack}*(A1−A2)−F_{friction}. Accordingly, Fₛₑₐₜ=P_{crack}*(A1−A2)−F_{friction}−F_{friction}−P*(A1−A2), resulting in:

Fₛₑₐₜ=P_{crack}*(A1−A2)−P*(A1−A2)−2*F_{friction}

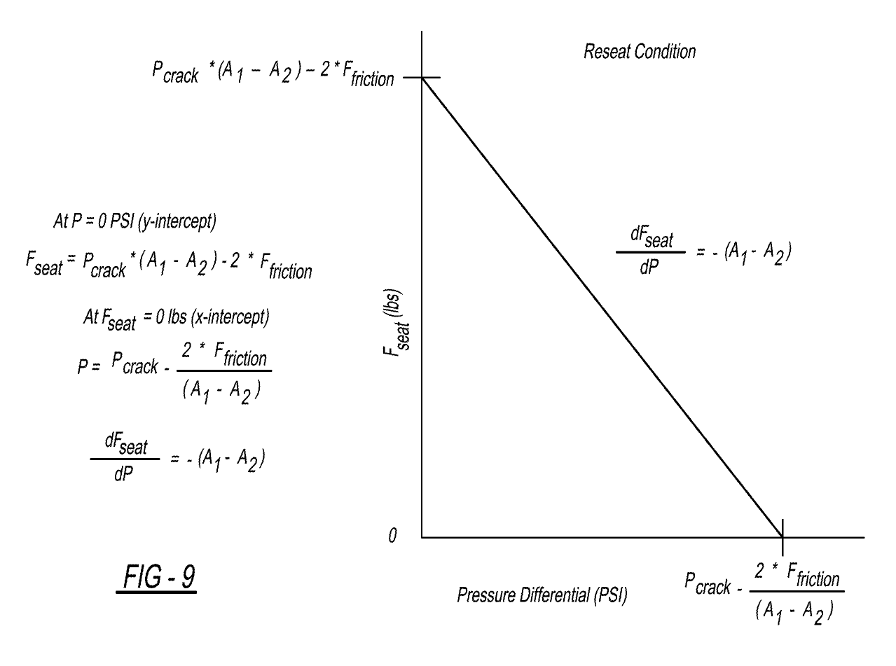

FIG. 9 illustrates a graph of the relationship between Fₛₑₐₜ and the pressure differential P across the valve 100 leading to the reseat condition.

When the pressure differential exceeds P_{crack}, the poppet 150 does not contact the valve seat 192. When Fₛₑₐₜ is zero, contact is reestablished and the pressure differential across the valve is P_{crack}−(2*F_{friction})/(A1−A2), as illustrated by the x-intercept of the illustrated graph. The force acting on the seat continues to build as the pressure differential falls. When the pressure differential reaches zero, the force acting on the valve seat 192, Fₛₑₐₜ, is equal to P_{crack}*(A1−A2)−2*F_{friction}. This is illustrated by the y-intercept of the illustrated graph. The relationship between Fₛₑₐₜ and the pressure differential P across the valve 100 is illustrated by the graph. When the pressure differential P is below the point at which the poppet re-contacts the seat but above 0, the Fₛₑₐₜ is also above zero, but smaller than P_{crack}*(A1−A2)−2*F_{friction}. The relationship between Fₛₑₐₜ and P can be determined using the following equation:

(dFₛₑₐₜ/dP)=(−(A1−A2))

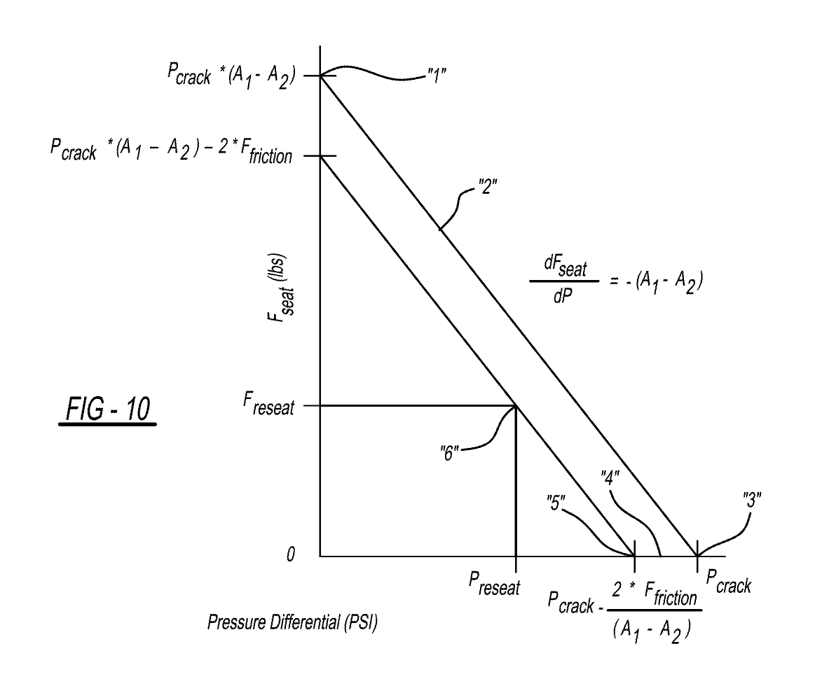

The pressure and force progressions for both the crack condition and the reseat condition are shown in FIG. 10, which illustrates how the valve 100 will “crack” and then reseat.

With reference to FIG. 10, at “1,” the starting point is at 0 PSI pressure differential across the valve 100. The pressure builds along the differential curve “2” but prior to crack. As pressure is building, Fₛₑₐₜ is decreasing. At point “3,” the valve 100 opens or “cracks.” Along “4,” the pressure decreases below the crack pressure but the poppet does not re-contact the seat due to friction from the seal. At point “5,” the poppet re-contacts the valve seat 192 at the o-ring 144. The o-ring 144 then flexes around all leak paths at the location of the valve seat 192 at point “6,” where P=Pᵣₑₛₑₐₜ.

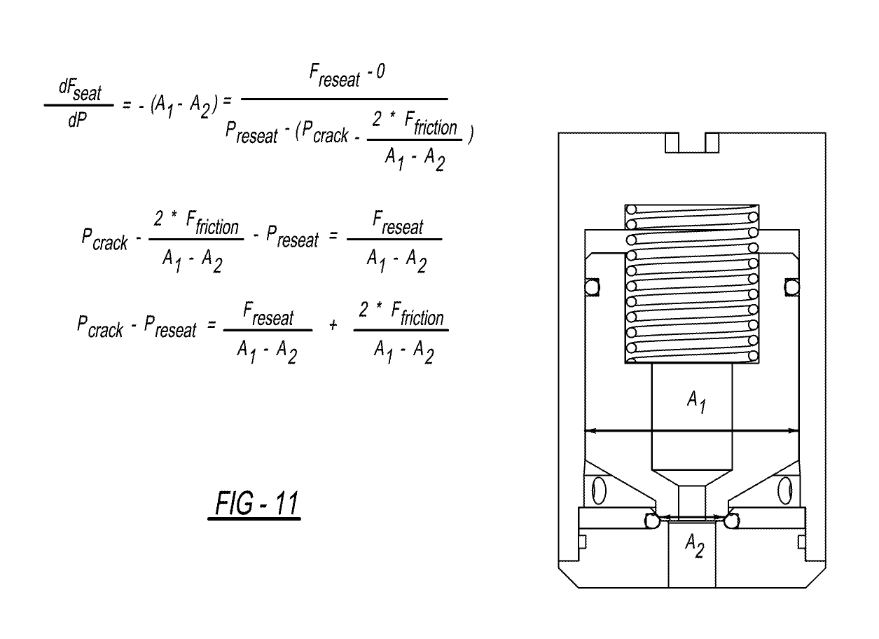

FIG. 11 includes additional equations related to the crack and reseat conditions. Reseat performance is improved by reducing the friction from the low friction sealing member 175 at the outer diameter of the poppet 150 and also by increasing the pressure area A (which equals A1−A2). Increasing the pressure area A1−A2 also reduces the effect of the friction. Thus, by increasing the pressure area A and by reducing the friction on the poppet 150, the difference between the P_{crack} and Pᵣₑₛₑₐₜ is smaller, resulting in faster reseat performance.

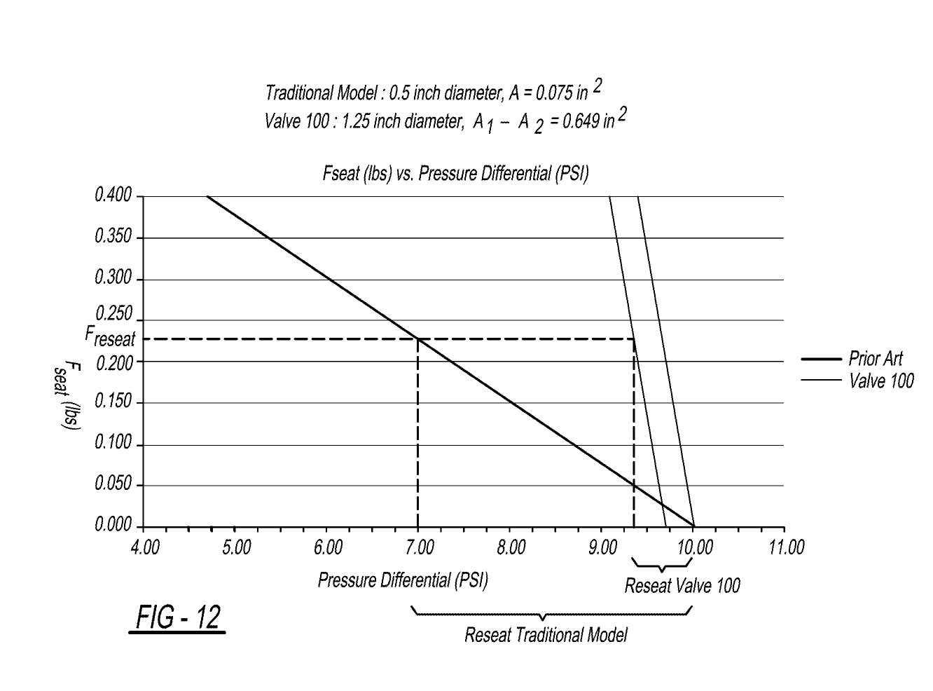

With reference to FIG. 12, in one embodiment, the valve has a diameter of approximately 1.25 inches, with A1−A2 being approximately 0.649 square inches. For comparison, one conventional valve has a 0.5 inch diameter with A equaling 0.075 square inches. Both valves use the same seal on the valve seat 192 and, therefore, each has a Fᵣₑₛₑₐₜ of approximately 0.225 lbs.

The conventional valve cracks at a pressure differential of approximately 10 psi and reseats when pressure differential is about 7.0 psi.

However, for the present embodiment of the valve 100, the valve 100 cracks at a pressure differential of approximately 10 psi, but reseats at a pressure differential of about 9.3 psi.

Accordingly, the valve 100 of the above embodiment reseats faster than the conventional valve, even though both valves are designed to crack at the same pressure.

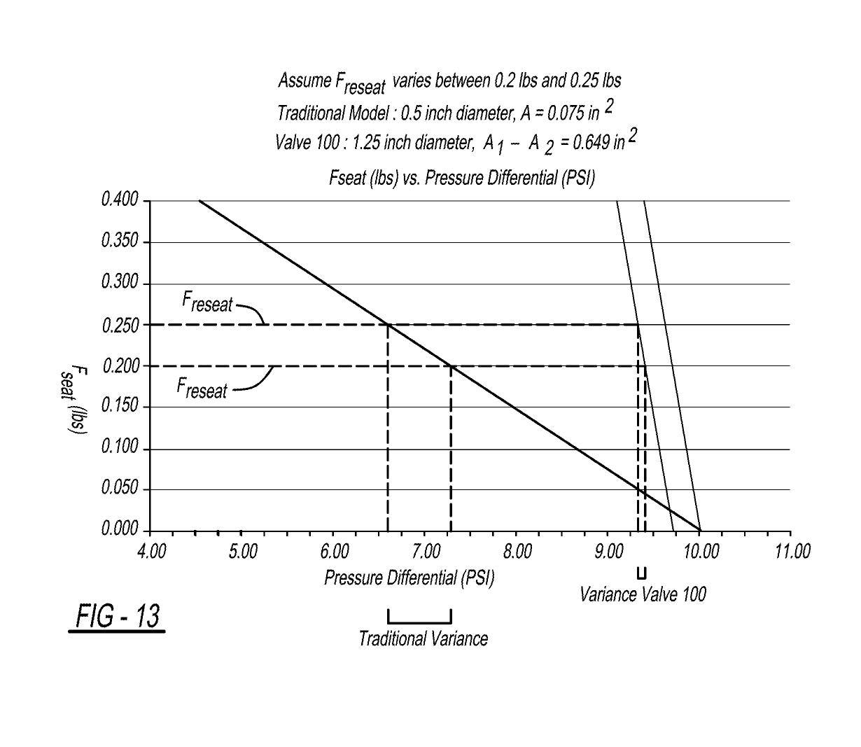

With reference to FIG. 13, in some cases, Fᵣₑₛₑₐₜ may vary for similarly designed valves, resulting in a variance of the pressure differential when reseat occurs.

In the above comparison, if the variance of Fᵣₑₛₑₐₜ is assumed to be from 0.2 lbs to 0.25 lbs., the above embodiment of the valve 100 has a smaller Pᵣₑₛₑₐₜ variance than the conventional valve.

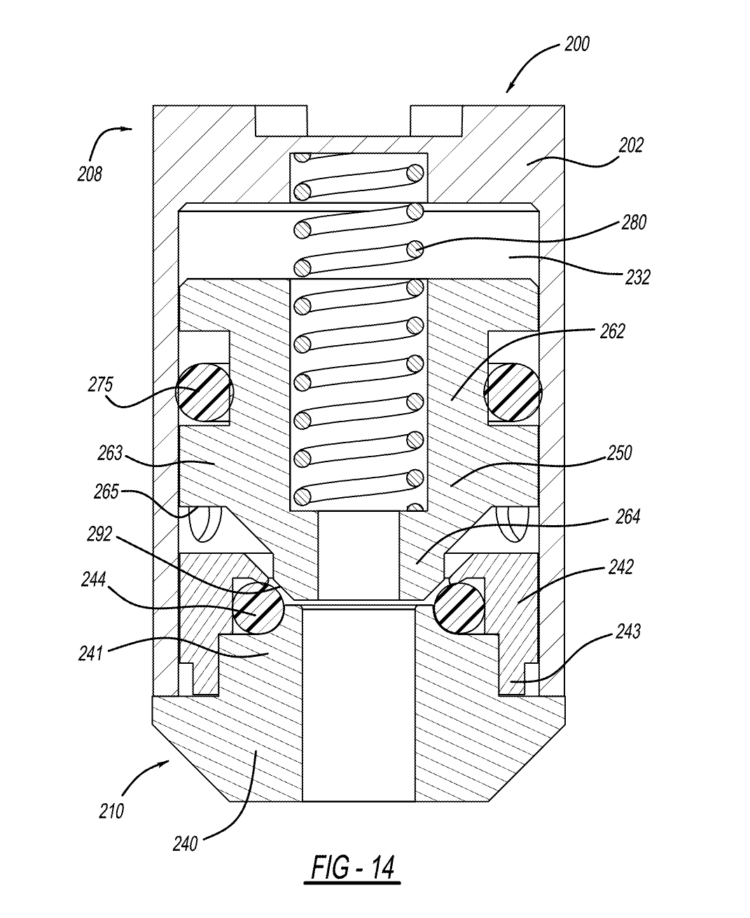

With reference to FIG. 14, an alternative embodiment of a valve 200 is provided having benefits similar to the valve 100. Unless otherwise noted, components having reference numbers ending with same two digits will operate in the same manner as the components in the 100 series and include similar features, and can include the same variations and modifications described above.

The valve 200 includes a cartridge 202 having a cap 240 and retainer 242 attached at an outlet end 210. A poppet 250 is housed within a cavity 232 of the cartridge 202 for slidable movement therein. A spring 280 is disposed within the cavity 232 that biases the poppet 250 toward the outlet end 210 and into engagement with an o-ring 244 that defines a valve seat 292.

The poppet 250 includes a tapered nose portion 264 and a body portion 262. The poppet 250 further includes a shoulder portion 263 that extends radially outward from the tapered nose portion, thereby defining an annular face 265.

The low friction sealing member 275 is disposed around the perimeter of the poppet 250 similar to the valve 100.

As shown in FIG. 14, the cap 240 and retainer 242 have different shapes than in valve 100. The cap 240 includes an axial protrusion 241 and a lip extending axially therefrom. The retainer 242 includes an annular rim 243 that corresponds to the size of the axial protrusion 241 such that the cap 240 is received in the retainer 242. The o-ring 244 is similarly sandwiched between the cap 240 and retainer 242.

The operation of the valve 200 is the same as described above with reference to valve 100. Similar to valve 100, the valve 200 defines areas A1 and A2 in the same manner, and results in more efficient reseat performance.

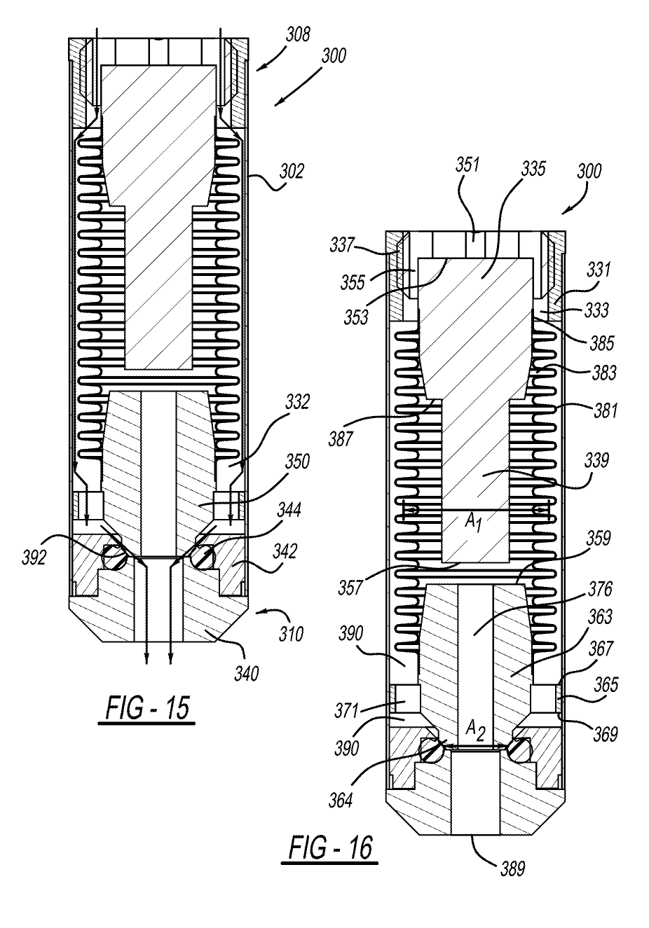

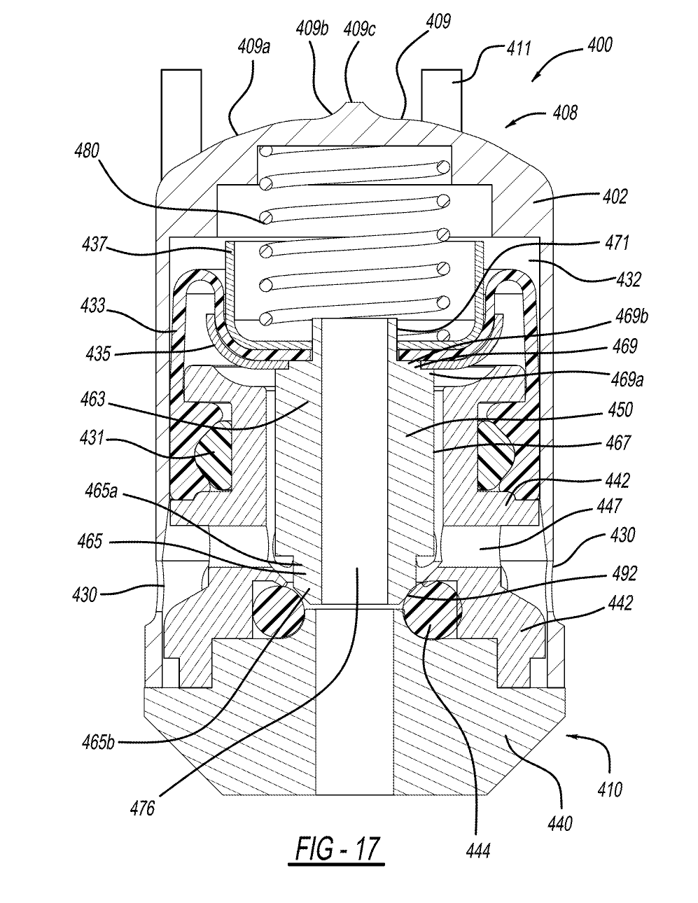

With reference to FIGS. 15 and 16, a further embodiment of a valve 300 with improved reseat performance is provided. The valve 300 includes a cartridge 302. The cartridge 302 can have a generally cylindrical shape without any flats, as the cartridge 302 is not designed for fluid to flow around the outside. Rather, fluid will flow through an inlet end 308 of the cartridge 302, as further described below. Accordingly, the cartridge 302 does not include any inlet ports extending through the side near its outlet end 310.

The cartridge includes a cap 340 and retainer 342 at the outlet end 310 similar to valves 100 and 200 and having a similar shape as the valve 200. An o-ring 344 is sandwiched between the retainer 342 and the cap 340 and defines a valve seat 392 similar to valves 100 and 200.

The valve 300 includes a poppet 350 disposed within a cavity 332 defined by the cartridge 302. The poppet 350 is arranged to slide longitudinally within the cavity 332 in response to a buildup of a pressure in a manner similar to valves 100 and 200 and to seal against the valve seat 392 when pressure is low.

The poppet 350 includes a tapered nose portion 364 similar to valves 100 and 200. However, the poppet 350 includes a body portion 363 that differs from valves 100 and 200. The body portion 363 includes a radially extending flange portion 365 that extends outward from the base of the tapered nose portion 364. The flange portion 365 includes an annularly arranged inlet face 367 facing toward the inlet end 308 of the valve 300 and an annularly arranged outlet face 369 facing toward the outlet end 310. The poppet 350 further includes a plurality of circumferentially arranged inlet ports 371 that extend through the flange portion 365 from the inlet face 367 to the outlet face 369, such that pressurized fluid can flow from the inlet face 367 to the outlet face 369.

The inlet ports 371 are preferably in the form of cylindrical bores or holes. However, the ports 371 could also have a different shape that allows for fluid to flow therethrough. The ports 371 could be the same shape of different shapes. In one approach, there are six ports 371, however other numbers of ports 371 could be used. The ports 371 are preferably arranged in a symmetrical pattern around the poppet 350, however they could be arranged such that some of the ports 371 are closer to others, or spaced at other circumferential intervals.

The poppet 350 defines a bore 376 or chamber extending axially and longitudinally through the center of the poppet 350. The bore 376 is arranged to be in fluid communication with the outlet chamber 389 of the valve 300 when the poppet 350 is seated against the valve seat 392.

The cartridge 302 further includes an inlet cap 331 attached to the inlet end 308 of the cartridge. The inlet cap 331 defines a central bore 333 that is sized and arranged to receive an inlet insert 335. In one approach, the inlet insert 335 is in the form of a screw insert that is threaded into the inlet cap 331. The inlet insert 335 extends into the cavity 332 of the cartridge and toward the poppet 350. The inlet insert 335 includes a head portion 337 and a neck portion 339, with the head portion 337 designed to attach to the inlet cap 331 and the neck portion 339 extending into the cartridge cavity 332.

The inlet insert defines a generally cylindrical receiving trough 351 that is open toward the inlet end 308 of the cartridge 302. The receiving trough 351 defines a receiving face 353 that is preferably flat and arranged transverse to the longitudinal axis of the valve 300. In another approach, the receiving face 353 can have a convex, concave, or irregular surface.

The inlet insert 335 further defines a plurality of inlet chutes 355 that extend longitudinally through the head portion 337 of the inlet insert 335. The inlet chutes 355 overlap the outer edge of the receiving trough 351, thereby defining a flow path through the head portion 337, where each inlet chute 355 is in fluid communication with the others via the receiving trough 351. The inlet chutes 355 accordingly provide fluid communication from outside of the inlet end 308 of the cartridge 302 into the cavity 332 of the cartridge 302.

The neck portion 339 of the inlet insert 335 extends into the cavity 332 from the head portion 337 and toward the poppet 350. The neck portion 339 further includes an end face 357 that faces toward the outlet end 310 of the cartridge and also toward the poppet 350. The poppet 350 includes an end face 359 that faces the end face 357 of the neck portion 339. The end faces 359 and 357 are spaced apart from each other when the poppet 350 is sealed against the valve seat 392.

Additionally, the cartridge 302 includes a bellows 381 that extends longitudinally within the valve cavity 332 from the poppet 350 toward the inlet end 308 of the cartridge 302. The bellows 381 has a zig-zag shaped sidewall and defines a bellows chamber 383 therein. The bellows chamber 383 is in fluid communication with the bore 376 of the poppet 350, and is therefore in fluid communication with the outlet end 310 of the cartridge 302 when the poppet 350 is seated. The bellows 381 includes an inlet end 385 that is arranged to fit tightly around the inlet insert 335.

The bellows 381 has a width that varies along its length in accordance with the zig-zag shape of the sidewall. The outer diameter of the bellows 381 is therefore greater at outer apices along its length than at inner apices. The outer diameter is smaller than the diameter of the cartridge cavity 332, thereby allowing fluid to flow around the outside of the bellows 381 and within the cavity 332 from the inlet end 308 toward the outlet end 310. The bellows 381 defines an effective diameter against which pressure will act, with the effective diameter being less than the outer diameter but greater than the inner diameter of the bellows 381.

The bellows 381 has an inherent spring bias that is built up when the bellows 381 is longitudinally compressed. Accordingly, when the poppet 350 moves away from the valve seat 392 and toward the inlet end 308, the bellows 381 will compress and exert a spring force back on the poppet 350 toward the outlet end 310, similar to the springs of the valves 100 and 200.

The valve 300 operates in a similar manner to valves 100 and 200, except with a different fluid flow path toward an inlet pressure chamber 390. Instead of fluid flowing around the outside of the cartridge 302, fluid flows around the outer perimeter of the cartridge 302 cavity within the cartridge cavity 332.

More particularly, fluid will flow into the receiving trough 351 of the inlet insert 335 and subsequently through the inlet chutes 355. Fluid will continue into the cartridge cavity 332 and toward the outlet end 310. Fluid will flow past the outer edge of the bellows 381 and toward the outlet end 310 the cartridge 302. When fluid reaches the inlet ports 371 of the poppet 350, fluid will flow therethrough and into the inlet pressure chamber 390 defined between the poppet 350 and the retainer 342. Fluid buildup in the inlet pressure chamber 390 will act to separate the poppet 350 from the valve seat. The inlet pressure chamber 390 is defined on both sides of the poppet flange 365, with pressure acting on both the poppet 350 and the bellows 381.

Rather than using an low friction sealing member as in valves 100 and 200, the bellows 381 acts as a seal to separate the pressure within the bellows 381 (corresponding to the outlet pressure when the poppet 350 is seated) from the pressure outside the bellows (corresponding to the inlet pressure when the poppet 350 is seated). As the poppet 350 moves away from the valve seat 392, the poppet 350 will move toward the inlet end 308 of the cartridge 302 and also toward the end face 357 of the inlet insert 335. The poppet 350 will be limited in its travel by the end face 357 of the inlet insert in the event the poppet 350 reaches the end face 357 of the inlet insert 335.

The pressure considerations described above regarding the crack condition and the reseat condition apply also to valve 300. The area A1 is defined by the effective diameter of the bellows 381, and the area A2 is defined by the width of the valve seat 392. In this approach, the area A1 is less than the width of the cavity 332, but still greater than area A2, resulting in a pressure area greater than one provided only by the valve seat of the prior art.

The valve 300 eliminates the use of the low friction seal member of valves 100 and 200, resulting in lower frictional forces. The bellows 381 is preferably made of a flexible metal material.

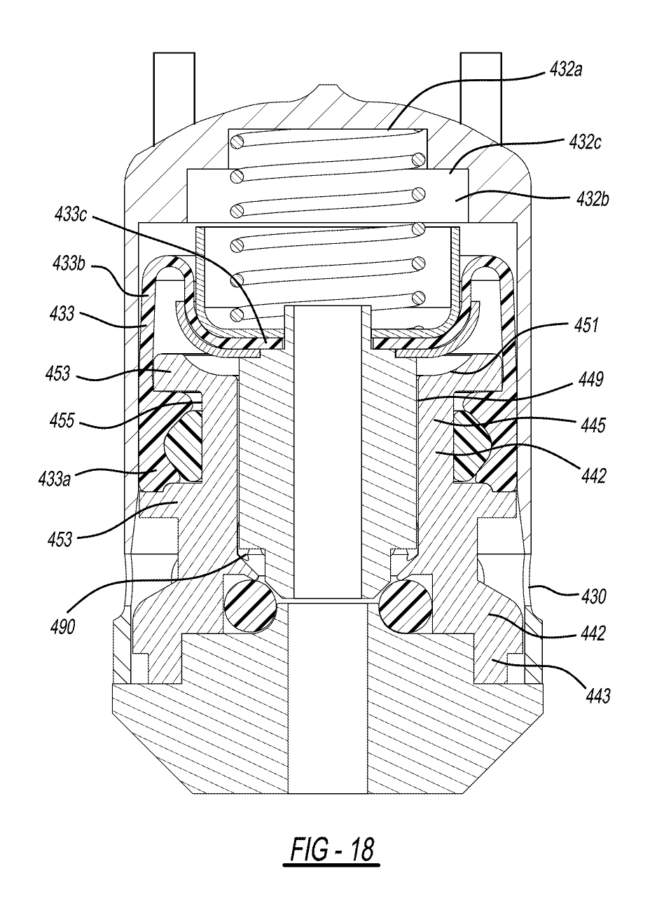

With reference to FIGS. 17 and 18, in yet another embodiment, a valve 400 is provided. The valve 400 operates similarly to the valves 100 and 200, as fluid flows around the outside of a cartridge 402.

The valve 400 includes the cartridge 402. The cartridge 402 includes a cap 440 and an o-ring 444 defining a valve seat similar to the caps and o-rings previously described. The retainer 442 has a different shape that previously described retainers and will be described in further detail below. The cartridge includes a poppet 450 disposed within a cartridge cavity 432 that is designed to slide longitudinally within the cartridge 402 away from a valve seat 492 similar to the valves 100-300.

The cartridge 402 has a generally cylindrical outer profile and therefore does not include the flats of the valves 100 and 200. The cartridge 402 includes an inlet end 408 and outlet end 410, with the inlet end 408 having a flow diverting surface 409 disposed at the inlet end 408. The diverting surface 409 has a generally complex curvature that is convex at an outer portion 409a and transitioning to concave at an inner portion 409b and further transitioning to a tip portion 409c. The tip portion 409c is disposed at the center of the diverting surface 409, such that pressurized fluid flowing toward the diverting surface 409 will be directed in multiple radial directions and generally evenly distributed around the outer profile of the cartridge 402. It will be appreciated that the flow diverting surface 409 can be altered to alter the flow path of pressurized fluid to direct it in a less evenly distributed fashion. The cartridge 402 is designed to be inserted into the bore of a valve body (not shown), such that fluid flows between the outer surface of the cartridge 402 and the inner surface of the valve body.

The cartridge 402 also includes a plurality of spacing posts 411 that extend longitudinally away from the inlet end 408 to ensure that fluid will be able to flow over the diverting surface 409. The spacing posts 411 are embedded into bored cavities defined by the inlet end 408 of the cartridge 402 in a manner known in the art.

The cartridge 402 further includes inlet ports 430 similar to the inlet ports of the valves 100 and 200. The inlet ports 430 permit fluid that is flowing past the outside of the cartridge 402 to enter the cartridge cavity 432. In one approach, there are 10 inlet ports 430 even spaced circumferentially about the cartridge 402; however, other quantities and spacing could be used. The inlet ports 430 are preferably in the form of equally sized circular holes, but the inlet ports 430 could also be different shapes and sizes relative to each other and spaced from each other at different circumferential intervals.

As described above, the cartridge 402 includes the retainer 442, which is disposed within the cavity 432 of the cartridge. The cartridge cavity 432 further includes additional components that work together with the poppet 450 to allow the poppet 450 to move away from the valve seat 492 and then reseat upon pressure relief. The cartridge 402 further includes an o-ring 431 that surrounds the retainer 442, a flexible and resilient diaphragm 433, a poppet cup member 435, a spring cup member 437, and a spring 480. These components and their relationship to each other and the poppet 450 will be described in further detail below.

The poppet 450 includes a body portion 463 and a nose portion 465 that extends longitudinally away from the body portion 463 toward the outlet end 410 and the valve seat 492. The nose portion 465 includes a tapered end portion 465b and a cylindrical portion 465a. The body portion 463 of the poppet 450 has a hexagonal or other polygonal outer profile, the body portion 463 of the poppet 450 thereby defining a plurality of flats 467 on the outer surface thereof. The body portion 463 includes a raised step portion 469 having a generally cylindrical shallow post shape that defines a shoulder 469a of the body portion 463. The shoulder 469a has a generally annular shape, with an outer edge corresponding to the polygonal shape of the body portion 463. The poppet 450 further includes a hollow cylindrical post portion 471 that extends longitudinally away from the step portion 469 and toward the inlet end 408 of the cartridge 402, which cooperates with the step portion 469 to define a step portion shoulder 469b.

The poppet 450 further defines a longitudinal bore 476 extending through the poppet 450 and centered on the central axis of the poppet 450. The bore 476 extends fully through the poppet 450, from the tapered end 465b of the nose portion 465 through the post portion 471. The post portion 471 is designed to be bent radially outward around its entire circumference by using, in one approach, a conical member (not shown) being hammered into the post in a direction toward the body portion 463. Of course, it will be appreciated that other methods of joining the components in this region can be used, such as threading, welding, or the like.

The polygonal outer profile of the poppet 450 allows fluid to flow past the outer surface of the poppet 450 when the poppet is housed within the retainer 442. The retainer 442 is disposed within the cavity 432 of the cartridge 402 and held in a stationary position, with the poppet 450 arranged to fit within the retainer 442 and slide relative to the retainer 442.

With reference to FIG. 18, the retainer 442 includes an outlet end 443 that is sized to correspond to the shape of the cap 440 and the o-ring 444, such that the cap 440 and o-ring 444 will be received and retained in the outlet end 443 of the retainer 442. The retainer 442 further includes a body portion 445 adjacent the outlet end 443 of the retainer 442. The body portion 445 of the retainer 442 defines a plurality of flow passageways 447, similar in style to the inlet ports 430. The flow passageways 447 are typically equal in size and shape and evenly distributed circumferentially around the retainer 442, thereby creating fluid communication between the outer surface of the retainer 442 and the inner surface of the retainer 442; however, other sizes, shapes, and spacing could be used. Preferably, ten circular flow passageways 447 are used.

The flow passageways 447 are preferably disposed near the inlet ports 430 of the cartridge and the nose portion 465 of the poppet 450, such that fluid flowing through the inlet ports 430 will subsequently flow radially through the flow passageways 447 and toward the nose portion 465 of the poppet 450. The retainer 442 defines a generally cylindrical bore 449 in which the poppet 450 is disposed, such that fluid that has flowed through the passageways 447 will continue past the poppet 450 between the poppet 450 and the inner surface of the retainer bore 449.

The retainer 442 further defines a recessed surface 451 at an end opposite the outlet end 443 of the retainer 442. The recessed surface 451 has a concave shape, and allows fluid flowing between the retainer 442 and the poppet 450 to flow radially outward.

The body portion 445 of the retainer 442 further includes a pair of radially projecting flanges 453 that combine to define an annular recess 455 therebetween. The annular recess 455 is designed to hold the o-ring 431, which surrounds the body portion 445 of the retainer 442. The o-ring 431 helps in sealing the diaphragm 433 against the cartridge 402.

The diaphragm 433 is disposed within the cartridge cavity 432 and is arranged to flex and roll as the poppet 450 moves away from and then back toward the valve seat 492. The diaphragm 433 includes a base portion 433a, a flexible body portion 433b, and an attachment portion 433c. The base portion 433a has an annular shape that is sized and configured to seal against the o-ring 431 that surrounds the retainer 442. The base portion 433a of the diaphragm 433 is compressed between the o-ring 431 and the inner surface of the cartridge 402 to hold the base portion 433a in place within the cartridge 402.

The attachment portion 433c defines a central hole and is sized and arranged to fit over the post 471 of the poppet 450 such that the attachment portion 433c rests against the step portion 469 of the poppet 450. Thus, when the poppet 450 moves away from the valve seat 492 and slides within the retainer 442, the attachment portion 433c will move with the poppet 450. The body portion 433b of the diaphragm 433 will then flex and roll to accommodate the movement of the poppet 450 and the attachment portion 433c of the diaphragm. Due to the rolling action of the diaphragm 433, frictional forces on the poppet 450 are reduced.

Additionally, the cartridge 402 includes the poppet cup member 435 that is disposed within the diaphragm 433 and between the diaphragm 433 and the poppet 450. The poppet cup member 435 has a generally concave shape and defines an opening that corresponds to the diameter of the step portion 469 of the poppet 450. The poppet cup member 435 provides support to the diaphragm 433, and ensures that fluid can flow past the poppet 450 and into the diaphragm 433.

The cartridge 402 further includes the spring cup member 437 that has a generally concave shape and defines an opening that corresponds to the diameter of the post portion 471 of the poppet 450. The spring cup member 437 is disposed over and around the post portion 471 and against the attachment portion 433c of the diaphragm. When the post portion 471 is radially expanded, as described above, the poppet cup member 435, the attachment portion 433c of the diaphragm 433, and the spring cup member 437 will be held in place to each other. It will be appreciated that these components can be held together in other ways, such as via welding, bonding, threaded connection, or the like.

The spring member 480 is disposed within the cartridge cavity 432 and extends between the spring cup member 437 and an inner end face 432a of the cartridge 402. When the poppet 450 moves away from the valve seat 492, the spring will compress and exert a biasing force against the poppet 450.

The cartridge 402 further defines an intermediate bore 432b that defines an annular stop face 432c. The intermediate bore 432b has a diameter that is slightly wider than the spring cup member 437. When the poppet 450 moves away from the valve seat 492, the spring cup member 437 will move toward the stop face 432c. Upon contacting the stop face 432c, the poppet 450 will be limited from further movement away from the valve seat 492.

The operation of the valve 400 with the cartridge 402 is similar to the operation described above with reference to valves 100 and 200. As fluid enters a pressure inlet chamber 490, fluid pressure will build up within the chamber 490. Fluid will flow past the poppet 450 and into a chamber defined by the diaphragm 433. Pressure will build up within the diaphragm 433 and around the poppet 450, causing the poppet 450 to separate from the valve seat 492 when pressure is high enough. The inlet pressure within the inlet chamber 490 and the diaphragm 433 is sealed from the outlet pressure when the poppet 450 is seated due to the seals at the valve seat and at the interface of the o-ring 431, the base portion 433a of the diaphragm 433, and the inner surface of the cartridge 402.

The area A1 is defined by the effective area of the diaphragm 433, with the area A2 being defined by the width of the valve seat 492. Fluid build-up prior to separation from the valve seat 492 will be sealed from the outlet pressure due to the seal of the diaphragm 433 against the inner surface of the cartridge 402 and to the poppet 450 around the post portion 471. The above described equations for “crack” and “reseat” apply similarly.

The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A cartridge for being inserted into a valve device for relieving a pressure buildup in a pressure system, the cartridge comprising:
a cartridge body having an inlet end and an outlet end and defining a cavity therein, wherein the inlet end is configured for being disposed toward the inlet side of the pressure system;
at least one inlet providing fluid communication between an area outside the cartridge and an area inside the cartridge
an outlet through which fluid can flow to relieve a pressure buildup within the cartridge;
a poppet disposed within the cavity of the cartridge body and being moveable longitudinally within the cavity;
a valve seat disposed within the cavity between the poppet and the outlet end of the cartridge body;
wherein the poppet has a first position being seated and sealed against the valve seat such that pressurized inlet fluid is separate from pressurized outlet fluid and the poppet has a second position being moved away from the valve seat, wherein pressurized inlet fluid is in fluid communication with pressurized outlet fluid;
wherein inlet pressure buildup within the cavity when the poppet is in the first position acts on the poppet to force the poppet away from the valve seat toward the inlet end of the cartridge body and away from the outlet end of the cartridge body, such that fluid will flow through the outlet to provide pressure relief.

2. The cartridge of claim 1, wherein the cartridge body includes a sidewall that defines an inner surface and a plurality of outer surfaces extending longitudinally from the inlet end to the outlet end, and the at least one inlet comprises a plurality of inlet ports extending through the sidewall.

3. The cartridge of claim 2, wherein the inlet end of the cartridge body is closed and pressurized fluid contacting the inlet end will flow over the inlet end and along the outer surfaces of the cartridge body toward the plurality of inlet ports.

4. The cartridge of claim 1, wherein the valve seat defines an opening having a first area and the cartridge defines a second area that is greater than the first area, wherein inlet pressure within the cartridge cavity acts against the second area when the poppet is in the first position and sealed against the valve seat and the inlet pressure is prevented from acting against the first area.

5. The cartridge of claim 4, wherein the cartridge body defines a pressure area comprising the difference between the second area and the first area, and the pressure area is greater than the first area.

6. The cartridge of claim 1 further comprising a spring disposed within the cartridge cavity between the poppet and the inlet end of the cartridge, wherein the spring biases the poppet toward the valve seat.

7. The cartridge of claim 1 further comprising a cap disposed at the outlet end of the cartridge body, wherein the cap defines the outlet of the cartridge.

8. The cartridge of claim 7 further comprising a retainer and an o-ring disposed radially within the retainer and between the retainer and the cap, the retainer and o-ring disposed on an inlet side of the cap, wherein the valve seat is defined at least in part by the o-ring.

9. The cartridge of claim 7, wherein the poppet defines a channel extending therethrough, to provide fluid communication between the outlet and an outlet pressure chamber defined at least in part by the poppet when the poppet is seated against the valve seat.

10. The cartridge of claim 9, wherein the outlet pressure chamber, poppet channel, and outlet are fluidly sealed from inlet pressure within the cartridge cavity when the poppet is seated against the valve seat.

11. The cartridge of claim 10, further comprising a sealing element extending circumferentially around the poppet and disposed between the poppet and the cartridge body, wherein the sealing element seals the outlet chamber, poppet channel, and outlet from the inlet pressure when the valve is seated, such that pressure buildup flowing through the inlet and into the cartridge cavity is separate from pressure buildup at the outlet when the poppet is seated against the valve seat.

12. The cartridge of claim 1 further comprising an inlet insert coupled to the inlet end of the cartridge body, the inlet insert including a plurality of inlet chutes extending longitudinally therethrough that provide fluid communication from the inlet end into the cartridge cavity, wherein fluid will flow through the inlet chutes toward the poppet and the valve seat.

13. The cartridge of claim 12 further comprising a longitudinally compressible bellows member attached to the poppet and extending between the poppet and the inlet insert, wherein the poppet includes a radially extending flange portion that defines a plurality of inlet ports therethrough and a body portion defining a longitudinally extending poppet channel therethrough to provide fluid communication between the outlet of the cartridge and an interior of the bellows, such that fluid flowing through the inlet chutes will flow past an outside surface of the bellows and through the inlet ports while being fluidly isolated from the interior of the bellows, the poppet channel, and the outlet when the poppet is seated against the valve seat.

14. The cartridge of claim 1, further comprising a rolling diaphragm attached to the poppet, the diaphragm sealing inlet pressure buildup within the cartridge cavity from pressure at the outlet defined by the cartridge when the poppet is seated against the valve seat, the diaphragm flexing and rolling in response to the poppet moving away from the valve seat.

15. The cartridge of claim 14 further comprising a retainer member disposed within the cartridge cavity and being longitudinally fixed within the cartridge cavity, the retainer defining a cylindrical bore, wherein the poppet is disposed within the cylindrical bore and being moveable longitudinally relative to the retainer, the retainer including at least one flow passageway that provides fluid communication between the inlet and the cylindrical bore, wherein pressurized fluid will flow through the inlet and the flow passageways and through the retainer bore between the poppet and the retainer into an interior of the diaphragm, wherein the pressurized fluid is isolated from the outlet when the poppet is seated against the valve seat.

16. The cartridge of claim 1, wherein the inlet end of the cartridge is closed and defines a flow diverting surface, the flow diverting surface having a complex curvature and diverting pressurized fluid to flow around the outer surface of the cartridge body.

17. A cartridge for being inserted into a valve device for relieving a pressure buildup in a pressure system, the cartridge comprising:
a cartridge body having an inlet end and an outlet end and defining a cavity therein, wherein the inlet end is configured for being disposed toward the inlet side of the pressure system and the outlet portion configured for being disposed toward the outlet side of the pressure system;
at least one inlet that provides fluid communication between an area outside the cartridge and an area inside the cartridge
an outlet through which fluid can flow to relieve pressure buildup within the cartridge;
a poppet disposed within the cavity of the cartridge body and being moveable longitudinally within the cavity;
a valve seat disposed within the cavity between the poppet and the outlet end of the cartridge body;
wherein the valve seat defines an opening having an outlet area measured transverse to the longitudinal axis of the cartridge, and the cartridge defines an inlet area measured transverse to the longitudinal axis of the cartridge, wherein the inlet area is greater than the outlet area, and a pressure area on which inlet pressure acts comprises a difference between the inlet area and the outlet area, the pressure area being greater than the outlet area;
wherein the poppet moves away from the valve seat to relieve a pressure buildup acting on the pressure area;
wherein fluid acting on the pressure area when the poppet is seated is sealed from the outlet.

18. The cartridge of claim 10, further comprising a sealing member in the form of an o-ring that surrounds the poppet and contacts an inner surface of the cartridge body, and the inlet area is defined by the outer diameter of the poppet, and the sealing member seals the fluid acting on the pressure area from the outlet.

19. The cartridge of claim 10, further comprising a bellows disposed within the cavity and attached to the poppet and an inlet insert coupled to the inlet end of the cartridge body, wherein fluid flows through the inlet insert and around an outer surface of the bellows toward the poppet, and the inlet area is defined by the effective diameter of the bellows, wherein the effective diameter of the bellows is less than an outer diameter of the poppet, and wherein the bellows seals the fluid acting on the pressure area from the outlet.

20. The cartridge of claim 10 further comprising a flexible rolling diaphragm attached to an end of the poppet opposite the valve seat and sealed against an inner surface of the cavity, wherein the inlet area is defined by an outer diameter of an interior cavity of the diaphragm, and the diaphragm seals the fluid acting on the pressure area from the outlet.

21. A method for relieving pressure buildup within a pressure system, the method comprising:
providing a cartridge comprising a cartridge body having an inlet end and an outlet end, a poppet disposed within the cartridge body, the cartridge defining an inlet and an outlet, the outlet being defined by a valve seat disposed within the cartridge, the poppet having a first position being biased toward and seated against the valve seat and a second position being moved away from the valve seat;
providing pressurized inlet fluid through the inlet of the cartridge into a cavity defined by the cartridge, where the pressurized inlet fluid is sealed from and isolated from the outlet;
building up pressure within the cartridge cavity, the pressure acting on a pressure area defined by the difference between an inlet area and an outlet area, the inlet area being defined by a diameter that is less than or equal to the diameter of the cartridge cavity, the outlet area being defined by the diameter of the valve seat, such that the pressure area has an annular shape;
in response to building up the inlet pressure, moving the poppet away from the valve seat, wherein the movement of the poppet away from the valve seat is in a direction toward the inlet end of the cartridge body and away from the outlet end of the cartridge body,
in response to moving the poppet away from the valve seat, reducing the pressure acting on the pressure area;
in response to reducing the pressure acting on the pressure area, moving the poppet toward the valve seat and re-seating the poppet on the valve seat.
